(19) United States
(12) Patent Application Publication
(10) Pub. No.: US 2023/0018507 A1
(43) Pub. Date: Jan. 19, 2023

(54) APPARATUS AND METHOD FOR SPECTROSCOPIC ANALYSIS ON INFRARED RAYS

(71) Applicant: ELECTRONICS AND TELECOMMUNICATIONS RESEARCH INSTITUTE, Daejeon (KR)

(72) Inventors: Soo Cheol KIM, Daejeon (KR); Kang Bok LEE, Daejeon (KR); Hyun Seok KIM, Daejeon (KR); Sang Hyun MO, Daejeon (KR); So Yung PARK, Daejeon (KR); Hoe Sung YANG, Daejeon (KR); Kwang Soo CHO, Daejeon (KR); Kyu Won HAN, Daejeon (KR)

(21) Appl. No.: 17/522,268

(22) Filed: Nov. 9, 2021

(30) Foreign Application Priority Data
Jul. 19, 2021 (KR) 10-2021-0094395

(51) Int. Cl. G01N 21/35; G01J 3/02

(52) U.S. Cl. CPC G01N 21/35; G01J 3/0229; G01J 3/0208; G01J 2003/2826

(57) ABSTRACT

Provided herein is an infrared spectroscopy technique capable of performing spectroscopic analysis on infrared rays in a broad infrared range (including a near infrared range, a short infrared range, a mid-infrared range, a far infrared range, and an extreme infrared range). An apparatus and a method for spectroscopic analysis on infrared rays are provided, without using an image sensor having a limited response range, to generate a signal in which transmitted light for each wavelength passes through a plurality of filters having different transmittances for each wavelength and is spatially pattern-coded, restore the signal into an infrared transmittance image, discriminate a wavelength according to a transmittance of the filter from the infrared transmittance image, calculate an intensity of the light for each wavelength, and output infrared spectrum information.

### CROSS-REFERENCE TO RELATED APPLICATION

This application claims priority to and the benefit of Korean Patent Application No. 10-2021-0094395, filed on Jul. 19, 2021, the disclosure of which is incorporated herein by reference in its entirety.

### BACKGROUND

### 1. Field of the Invention

The present invention relates to infrared spectroscopy, and more particularly, to an apparatus and a method for spectroscopic analysis on infrared rays, which are capable of performing spectroscopic analysis on broad ranges of infrared rays (including a near infrared, a short infrared, a mid-infrared, a far infrared, and an extreme infrared).

### 2. Description of Related Art

Spectral measurement or analysis on ultraviolet rays, visible rays, and infrared rays is used in various fields such as material component analysis, bio-health care, and the defense industry. In particular, through infrared spectral analysis, it is possible to effectively analyze volatile organic compounds and transparent liquid chemical samples with insignificant absorption in visible light and to detect heat-generating objects or to measure a temperature.

Conventionally, there is a near-infrared spectroscopic analysis technique using a near-infrared transmission filter and a two-dimensional image sensor (e.g., a complementary metal-oxide semiconductor (CMOS), a charge-coupled device (CCD), or the like). According to the conventional apparatus for spectroscopically analyzing near-infrared rays shown in FIG. 1, incident light 1 is split into pieces of light for each wavelength through a near infrared spectral filter array 3 and is acquired as a spectroscopic image 7 of which wavelengths are separated and displayed by an image sensor 5. Various wavelength components λ₁ to λ₁₆ included in the incident light 1 can be analyzed from the spectroscopic image 7.

However, in such a conventional spectroscopic analysis apparatus, since a response range of the image sensor with respect to electromagnetic wave wavelengths is limited, spectral measurement is possible only from a visible wavelength to a near-infrared wavelength so that there is a problem in that spectroscopic analysis is impossible with respect to short infrared rays, mid-infrared rays, far infrared rays, and extreme infrared rays, which have wavelengths that are longer than the visible wavelength to the near-infrared wavelength.

### SUMMARY OF THE INVENTION

The present invention is directed to solving the above problems, and an infrared spectroscopy technique capable of performing spectroscopic analysis on infrared rays in a broad infrared range (including a near infrared range, a short infrared range, a mid-infrared range, a far infrared range, and an extreme infrared range) is provided.

According to the present invention, an apparatus and a method for spectroscopic analysis on infrared rays are provided, without using an image sensor having a limited response range, to generate a signal in which transmitted light for each wavelength passes through a plurality of filters having different transmittances for each wavelength and is spatially pattern-coded, acquire the signal using an optical detector with a very broad response range, restore the signal into an infrared transmittance image, discriminate a wavelength according to a transmittance of the filter from the infrared transmittance image, calculate an intensity of the light for each wavelength, and output infrared spectrum information.

According to an aspect of the present invention, there are provided an apparatus and a method for spectroscopic analysis on infrared rays, which split light to be analyzed into pieces of light having different wavelengths according to a filter position when the light to be analyzed at a different transmittance for each wavelength is uniformly emitted to a spectral filter, pattern-encode and modulate the pieces of split light for each wavelength, detect the pattern-encoded modulated signal using an optical detector, restore the detected pattern-encoded signal into an infrared transmittance image, and discriminate a wavelength according to a filter position from the infrared transmittance image and correct an intensity of light according to each filter transmittance, thereby generating infrared spectrum information.

Here, during the spectroscopy, a diffuser for uniformly emitting light and an infrared spectral filter array capable of performing spatial spectroscopy may be used. In addition, during the modulation, a spatial light modulator may be used to pattern-encode the split light.

The pattern-encoded signal may be a one-dimensional signal, and the restored infrared transmittance image may be two-dimensional spatial information.

The above-described configurations and operations of the present invention will become more apparent from embodiments described in detail below with reference to the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a conventional apparatus for spectroscopically analyzing near infrared rays;

FIG. 2 is a schematic diagram illustrating an apparatus and a method for spectroscopic analysis on infrared rays according to the present invention;

FIG. 3 is a block diagram illustrating an apparatus and a method for spectroscopic analysis on infrared rays according to an embodiment of the present invention;

FIG. 4A shows a diagram illustrating a measurement target infrared signal incident light;

FIG. 4B is a diagram illustrating a one-dimensional optical signal including encoded pattern information;

FIG. 5A shows a diagram illustrating a restored infrared transmittance image; and

FIG. 5B is a diagram illustrating infrared spectrum information.

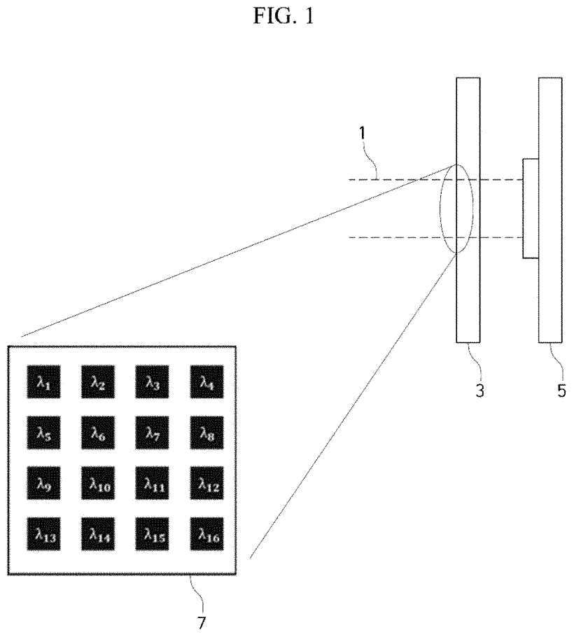

### DETAILED DESCRIPTION OF EXEMPLARY EMBODIMENTS

Advantages and features of the present invention and methods for achieving them will be made clear from exemplary embodiments described in detail below with reference to the accompanying drawings. However, the present invention is not limited to the embodiments described below and may be implemented in various other forms. The embodiments are provided such that this disclosure will be thorough and complete and will fully convey the scope of the present invention to those skilled in the art to which the present invention pertains, and the present invention is defined only by the scope of the appended claims. In addition, terms used herein are for the purpose of describing the embodiments and are not intended to limit the present invention. In this disclosure, the singular forms include the plural forms unless the context clearly dictates otherwise. The term “comprises XX” or “comprising XX” used herein does not preclude the presence or addition of one or more other elements, steps, operations, and/or devices (or components) other than elements, steps, operations, and/or devices (or components), which are stated as XX.

Hereinafter, exemplary embodiments of the present invention will be described in detail with reference to the accompanying drawings. In describing the embodiments, if a detailed description of related known configurations or functions is determined to obscure the gist of the present invention, the detailed description thereof will be omitted.

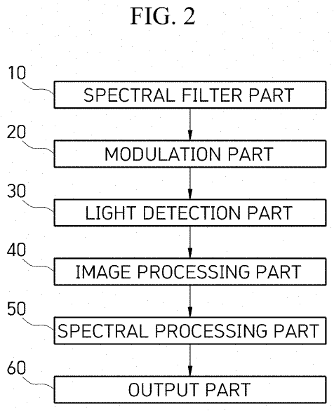

FIG. 2 is a schematic diagram for describing a concept of the apparatus and the method for spectroscopic analysis on infrared rays according to the present invention. The apparatus and the method for spectroscopic analysis on infrared rays include: a spectral filter part 10 for splitting light to be analyzed into pieces of light having different wavelengths according to a filter position when the light to be analyzed at a different transmittance for each wavelength is uniformly emitted to a spectral filter; a modulation part 20 for pattern-encoding the split light for each wavelength to generate a pattern-encoded signal; a light detection part 30 for detecting and acquiring the pattern-encoded signal; an image processing part 40 for restoring the detected pattern-encoded signal into an infrared transmittance image; a spectral processing part 50 for discriminating a wavelength according to a filter position from the infrared transmittance image and correcting an intensity of light according to each filter transmittance, thereby generating infrared spectrum information; and an output part 60 which outputs the generated infrared spectrum information.

The spectral filter part 10 includes a spectral filter array having a different transmittance for each wavelength of light to be analyzed. When the light to be analyzed is uniformly emitted to the spectral filter, the light to be analyzed is split into pieces of light having different wavelengths for positions of arrayed filters. In addition, the spectral filter part 10 may include a diffuser for uniformly emitting the light to be analyzed to the spectral filter array.

The modulation part 20 encodes the pieces of light, which are split by the spectral filter part 10, into a spatially different pattern. The modulation part 20 may be implemented as a spatial light modulator.

The light detection part 30 acquires all pieces of light modulated by the modulation part 20. The light detection part 30 may include an optical element such as a lens.

The image processing part 40 restores a difference in transmittance of the light, which is obtained in the light detection part 30 and passes through the filter array of the spectral filter part 10, into a two-dimensional image.

The spectral processing part 50 converts the spatial position information of the two-dimensional image restored by the image processing part 40 and the light intensity measured for each position to the light intensity as a function of wavelength. To do that, the spectral processing part 50 is configured to discriminate wavelengths according to the spatial position from the two-dimensional image restored by the image processing part, correct the light intensity according to each filter transmittance, and generate infrared spectrum information.

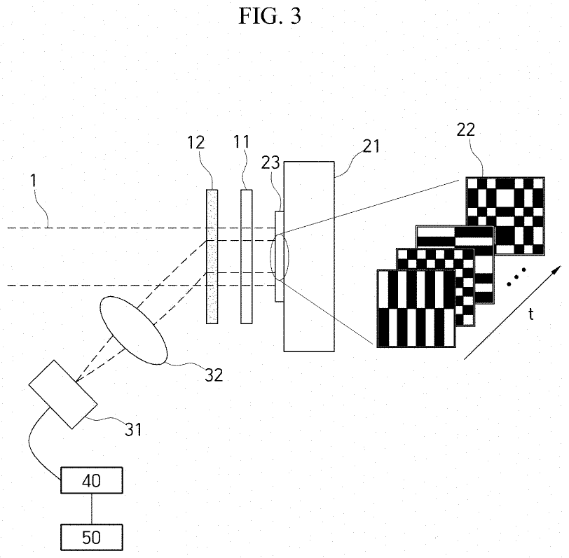

Each of the above components will be described in more detail with reference to FIG. 3, which is a block diagram illustrating an apparatus and a method for spectroscopic analysis on infrared rays according to an embodiment of the present invention.

According to the embodiment of FIG. 3, the spectral filter part 10 in FIG. 2 includes an infrared spectral filter array 11 and a diffuser 12. The incident light 1 to be analyzed passes through the diffuser 12 and thus passes through the infrared spectral filter array 11 in a state in which a light intensity is uniform, and the incident light 1 is split into the pieces of light having different wavelengths according to two-dimensional spatial positions. Here, the infrared spectral filter array 11 may be implemented as a prism, a diffraction grating, a Fabry-perot filter, or a nano-structure filter using a surface plasmon polariton.

The modulation part 20 in FIG. 2 is implemented as a spatial light modulator 21. The spatial light modulator 21 is formed of a two-dimensional micro-arrayed mirror and may drive to turn a mirror on/off at a specific position in space in the same way as a structure of a one-bit image. As shown in FIG. 3, the spatial light modulator 21 reflects light only at a specific position by a mirror 23 on which predetermined encoding patterns 22 are formed. One of the examples of the encoding pattern 22 may include a Hadamard matrix in which all components are +1 and −1 and rows and columns are orthogonal to each other, where N² patterns are required, assuming the size of the matrix is N×N. The light split by the infrared spectral filter array 11 are encoded into N² different patterns 22 modulated by the spatial light modulator 21 during the driving time t and then reflected (2). Here, the spatial light modulator 21 may be implemented as a spatial light modulator (SLM), a digital mirror device (DMD), an acousto-optic modulator (AOM), a pattern disk, or the like. In addition, the pattern encoding may be implemented as a random pattern, a structured pattern, a Fourier pattern, a Hadamard pattern, or the like.

An optical detector 31 of the light detection part 30 acquires a signal of the reflected light 2 modulated by the spatial light modulator 21. The optical detector 31 may be implemented as one of various types of detection devices using Si, InGaAs, InAsSb, HgCdTe, and a thermocouple. Unlike an image sensor formed in a two-dimensional pixel array structure, the optical detector 31 is formed as one pixel and may measure ultraviolet rays, visible rays, near infrared rays, short infrared rays, mid-infrared rays, far infrared rays, and extreme infrared rays according to a type of the detection device. In addition, the light detection part 30 may include an optical element such as a lens 32.

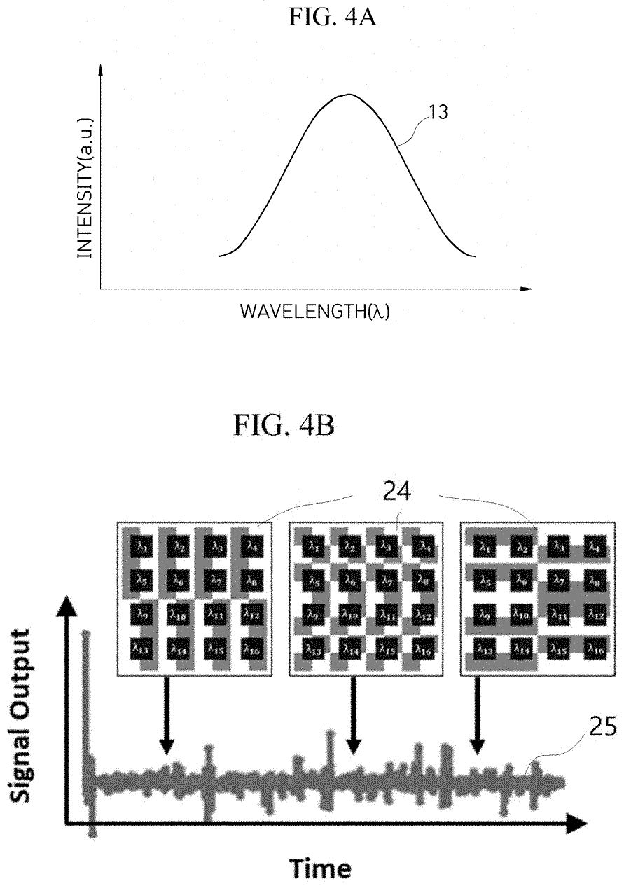

The reflected light 2 acquired by the optical detector 31 is a pattern-encoded one-dimensional signal by the spatial light modulator 21. An incident infrared light signal 13 to be analyzed is shown in FIG. 4A, and FIG. 4B shows a one-dimensional signal 25 obtained by spatially pattern-encoding light transmitted through the infrared spectral filter array 11 using the spatial light modulator 21.

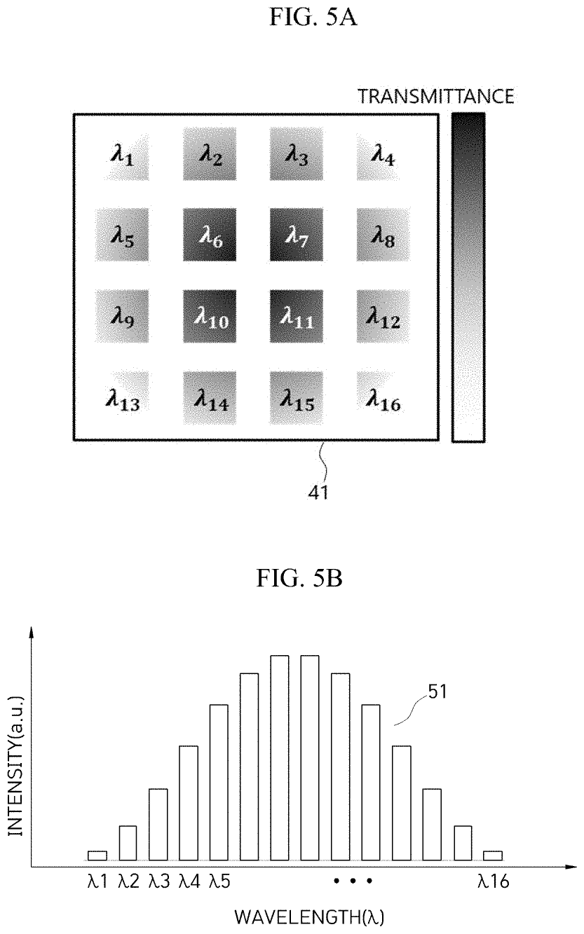

Referring to FIG. 3 again, the image processing part 40 acquires a one-dimensional optical signal 25 (see FIG. 4B) having the size of N²×1 obtained by the optical detector 31 through the pattern-encoding of N² times for a predetermined time. The measured one-dimensional matrix of size N²×1 is obtained as a one-dimensional infrared transmittance of size N²×1 by matrix-multiplication of a two-dimensional Hadamard matrix of size N²×N². The one-dimensional infrared transmittance of size N²×1 is rearranged into a two-dimensional matrix of size N×N, and the infrared transmittance image 41 of FIG. 5A is restored. The restored infrared transmittance image 41 is illustrated in FIG. 5A. It can be seen that, since the transmittance of infrared rays including different wavelengths of λ₁ to λ₁₆ is different for each filter position of the infrared spectral filter array 11, each wavelength is displayed in a different tone.

The spectral processing part 50 performs signal processing to obtain the light intensity as a function of wavelength from the restored two-dimensional transmittance image. To do this, different wavelength values for spatial positions in the restored two-dimensional transmittance image are re-arranged into a one-dimensional matrix in the order from a low wavelength to a high wavelength. An element of the rearranged matrix indicates a transmittance of each wavelength and is light intensity as a function of wavelength. Consequently, infrared spectrum information 51 in which the light intensity is calculated for each wavelength is obtained. The infrared spectrum information 51 is shown in FIG. 5B.

Finally, the output part 60 outputs the obtained infrared spectrum information 51.

In accordance with an apparatus and a method for spectroscopic analysis on infrared rays according to the present invention, miniaturization and versatility are excellent when compared with the existing infrared spectroscopic apparatus, and thus the apparatus and the method for spectroscopic analysis on infrared rays can be easily used in various industrial fields. In addition, when compared with the existing infrared spectroscopic apparatus, the apparatus and the method for spectroscopic analysis on infrared rays can be formed at a lower cost so that an economical effect can be increased.

Although the configuration of the present invention has been described in detail with reference to the accompanying drawings, this is merely an example and modifications and alternations within the scope of the technical spirit of the present invention can be devised by those skilled in the art to which the present invention pertains. Therefore, the protection scope of the present invention should not be limited to the above-described embodiments and should be defined by the description of the appended claims.

What is claimed is:

1. An apparatus for spectroscopic analysis on infrared rays, comprising:
a spectral filter part configured to split light to be analyzed into pieces of light having different wavelengths according to a spatial position when the light to be analyzed at a different transmittance for each wavelength is uniformly emitted to a spectral filter and;
a modulation part configured to modulate the pieces of light, which are split with the different wavelengths, into a pattern-encoded signal;
a light detection part configured to detect the pattern-encoded signal;
an image processing part configured to restore a difference in transmittance of the pieces of light, which are detected by the light detection part and which pass through the spectral filter part, into a two-dimensional image; and
a spectral processing part configured to discriminate wavelengths according to the spatial position from the two-dimensional image restored by the image processing part, correct an intensity of the light according to each filter transmittance, and generate infrared spectrum information.

2. The apparatus of claim 1, wherein the spectral filter part includes an infrared spectral filter array which has a different transmittance for each wavelength of the light to be analyzed and is configured to split the light into the pieces of light having different wavelengths according to a two-dimensional spatial position.

3. The apparatus of claim 2, wherein the infrared spectral filter array includes a nano-structure filter using one selected from among a prism, a grating, a Fabry-perot filter, and a surface plasmon polariton.

4. The apparatus of claim 2, wherein the spectral filter part further includes a diffuser configured to uniformly emit the light to be analyzed to the infrared spectral filter array.

5. The apparatus of claim 1, wherein the modulation part includes a spatial light modulator having a two-dimensional micro-arrayed mirror configured to reflect only light at a specific position by a mirror on which an encoding pattern is formed so as to encode the pieces of light split by the spectral filter part into a spatially different pattern.

6. The apparatus of claim 5, wherein the spatial light modulator is selected from among a spatial light modulator (SLM), a digital mirror device (DMD), an acousto-optic modulator (AOM), and a pattern disk.

7. The apparatus of claim 5, wherein the encoding pattern is selected from among a random pattern, a structured pattern, a Fourier pattern, and a Hadamard pattern.

8. The apparatus of claim 1, wherein the light detection part includes an optical detector which is formed as one pixel, is made of a detection element selected from among Si, InGaAs, InAsSb, HgCdTe, and a thermocouple, and is allowed to measure ultraviolet rays, visible rays, near infrared rays, short infrared rays, mid-infrared rays, far infrared rays, and extreme infrared rays according to a type of the detection element.

9. The apparatus of claim 1, wherein the infrared spectrum information generated by the spectral processing part includes a transmittance value of each wavelength included in the light to be analyzed.

10. A method of spectroscopic analysis on infrared rays, comprising:
splitting light to be analyzed into pieces of light having different wavelengths according to a spatial position when the light to be analyzed at a different transmittance for each wavelength is emitted to a spectral filter;
modulating the pieces of light, which are split with the different wavelengths, into a pattern-encoded signal;
detecting the pattern-coded signal;
restoring a difference in transmittance of the pieces of detected light into a two-dimensional image; and
discriminating wavelengths according to the spatial position from the restored two-dimensional image, correcting an intensity of the light according to each filter transmittance, and generating infrared spectrum information.

11. The method of claim 10, wherein the splitting is performed using an infrared spectral filter array which has a different transmittance for each wavelength of the light to be analyzed and is configured to split the light into the pieces of light having different wavelengths according to a two-dimensional spatial position.

12. The method of claim 10, wherein the modulating is performed using a spatial light modulator having a two-dimensional micro array mirror configured to reflect only light at a specific position by a mirror on which an encoding pattern is formed so as to encode the split light into a spatially different pattern.

13. The method of claim 12, wherein the encoding pattern is selected from among a random pattern, a structured pattern, a Fourier pattern, and a Hadamard pattern.

14. The method of claim 10, wherein the detecting is performed using an optical detector which is formed as one pixel, is made of a detection element selected from among Si, InGaAs, InAsSb, HgCdTe, and a thermocouple, and is allowed to measure ultraviolet rays, visible rays, near infrared rays, short infrared rays, mid-infrared rays, far infrared rays, and extreme infrared rays according to a type of the detection element.

15. The method of claim 10, wherein the infrared spectrum information generated in the generating of the infrared spectrum information includes a transmittance value of each wavelength included in the light to be analyzed.
